(19) United States
(12) Patent Application Publication
(10) Pub. No.: US 2003/0051796 A1
(43) Pub. Date: Mar. 20, 2003

(54) Self-adhesive strap structure facilitating patterned mark formation

(76) Inventor: Shih-Sheng Yang, Taipie City (TW)

Correspondence Address: Shih-ShengYANG, PO Box 82-144, TAIPEI, TW

(21) Appl. No.: 09/956,050

(22) Filed: Sep. 20, 2001

(51) Int. Cl. B31F 1/00; B29C 47/00

(52) U.S. Cl. 156/209; 156/245

(57) ABSTRACT

A self-adhesive strap structure facilitating patterned mark formation is disclosed. The blanket face of the blanket portion is first formed and the blanket face having needle-like top mold is placed into the mold. A high-pressure ejection-molding step is used to provide plastic material to the rear side of the blanket face for fusion so that the plastic board body is formed as one unit with the rear side of the blanket face so as to provide best strength. The plastic board body is to be formed with a specific patterned mark so that the self-adhesive strap that formed can be designed with a mark for recognization.

### BACKGROUND OF THE INVENTION

(a) Field of the Invention

The present invention relates to a self-adhesive strap structure, and in particular, a strap structure which can be provided with a patterned mark thereof.

(b) Description of the Prior Art

FIG. 1 shows a blanket portion of a conventional self-adhesive strap having a blanket face 31 and a strap body 32 made from a hard material. In this conventional structure, a stitching procedure is needed to mount the blanket face 31 and the strap body 32 together as a blanket portion 3. Together with the filament-implanting portion 4 having mounted with a plurality of filaments 41, a self-adhesive strap is obtained.

The drawback of this conventional structure is that a stitching process is required and is laborious and the cost of manufacturing is high. In addition, the mounting of the blanket face 31 with the strap body 32 is poor, and as a result of frequent pulling from self-adhesion, the blanket face 31 and the strap body 32 may be damaged. Therefore, it is an object of the present invention to provide a self-adhesive strap structure facilitating patterned mark formation which mitigates the above drawback

### SUMMARY OF THE INVENTION

Accordingly, it is an object of the present invention to provide a self-adhesive strap structure facilitating patterned mark formation including a blanket portion having a blanket face and a plastic board body, and a filament-implanting portion having a surface mounted with filaments, and the surface of the blanket-face being provided with a plurality of protruded, hooked blanket bodies, characterized in that the plastic board body is directly ejected via a fabrication molding device onto the rear side of the blanket face, thereby the blanket face is fused with the plastic board body as one unit to form the self-adhesive strap.

Yet another object of the present invention to provide a self-adhesive strap structure facilitating patterned mark formation, wherein no stitching process is required in mounting the blanket face with a thin hard strap.

A further object of the present invention to provide a self-adhesive strap structure facilitating patterned mark formation, wherein the manufacturing process can be simplified and the cost of production is lowered.

A further object of the present invention to provide a self-adhesive strap structure facilitating patterned mark formation, wherein the separation of the self-adhesive strap provided onto a garment is easy, and a patterned mark can be provided thereof

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional self-adhesive strap.

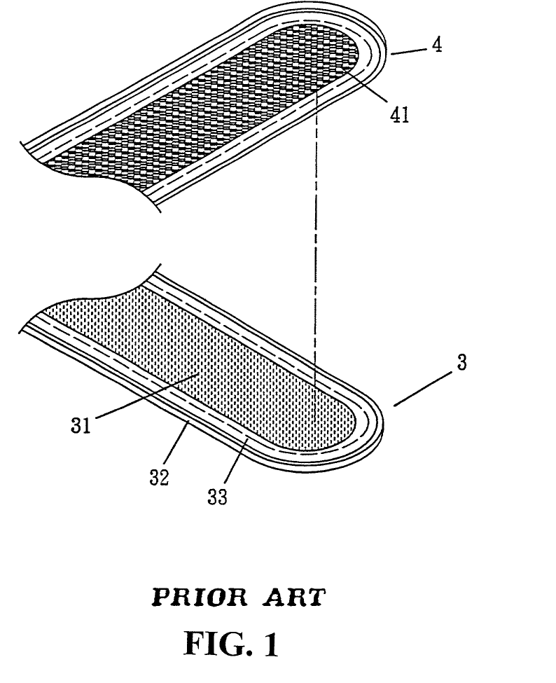

FIG. 2 is a perspective exploded view of the self-adhesive strap of the present invention.

FIG. 3 is a perspective view of the self-adhesive strap of the present invention.

FIG. 4 shows the external view of the present invention, wherein the formed plastic board body is provided with a specific mark.

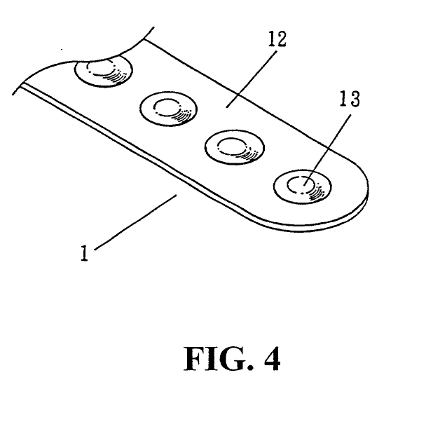

FIG. 5 is an illustrative view of the present invention in FIG. 2.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

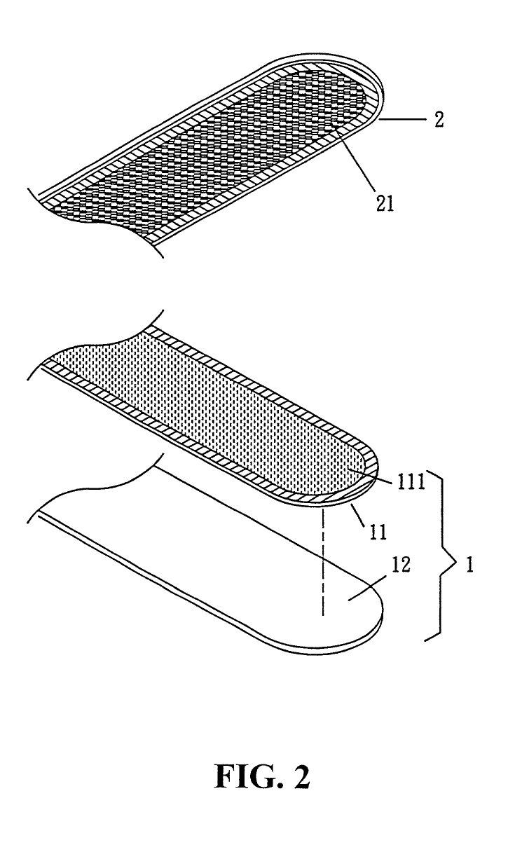

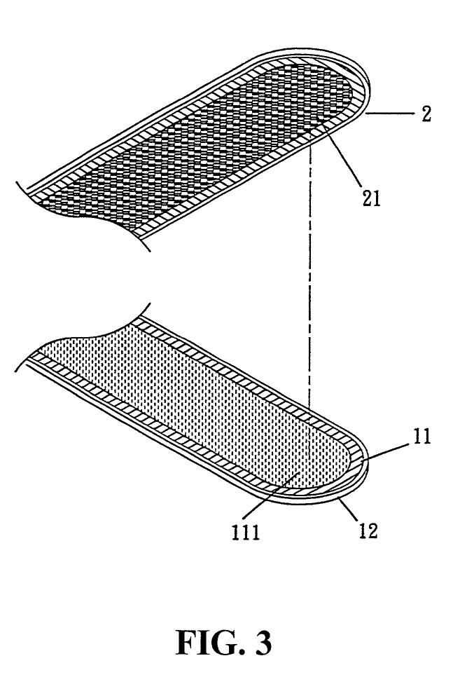

Referring to FIGS. 2 and 3, there is shown a self-adhesive strap structure facilitating patterned mark formation. The structure of the present invention comprises a blanket portion 1 and a filament-implanting portion 2, wherein the blanket portion 1 includes a blanket face 11 and a plastic board body 12. The surface of the blanket face 11 s provided with a plurality of protruded blanket bodies 111 having a hook-like shape at the end portion thereof. The surface of the filament-implanting portion 2 is provided with wound filaments 21.

In manufacturing, the blanket bodies 111 having the hook-like shape face is placed into the molding device such that the hook-like shape face is facing the inside of the mold. The mold cavity at the bottom of the mold is provided with a top mold having a plurality of needle-like members for positioning and supporting. The circumferential edge of the mold slightly presses the side edge of the blanket face to prevent the blanket face from dislocation from the mold as a result of ejection molding of the plastic material. Thus, the top mold with needle-like members support the uneven blanket body, and the circumferential edge of the blanket body 111 is slightly pressed and supported. At one ejection molding, the plastic board body 12 is completely mounted at the rear side of the blanket face 11.

Thus, the plastic board body 12 is formed as one unit with the blanket face 11 and in utilization, the plastic board body 12 is combined with a hard elongated strap, and when it is used in the glove for skiing, the glove can be removed by pulling away the self-adhesive strap made from this material.

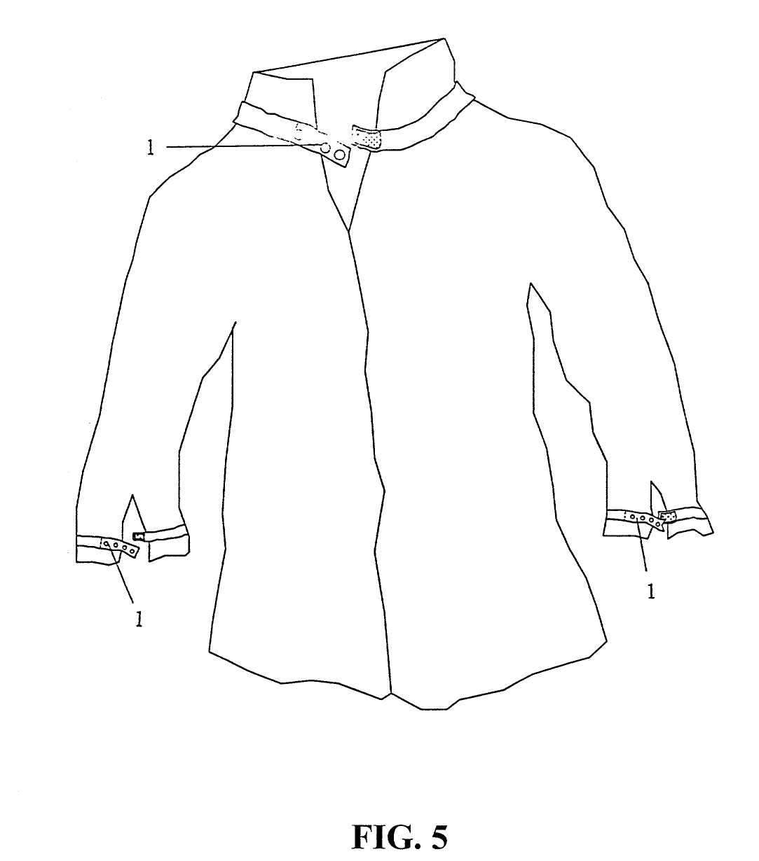

As shown in FIG. 5, the exposed surface of the plastic board body 12 can be provided with any specific patterned marks 13 to promote sales.

In accordance with the present invention if the blanket portion 12 and the filament portion 2 are to be separated or adhered a hand is used to hold the plastic board body 12 so as to control the adhesion of the filaments 21. The one unit structure of the blanket face 11 and the plastic board body 12 provides a strong adhesion without a stitching process. Thus, the cost of production is lowered and the process of manufacturing is simplified

FIG. 5 is a preferred embodiment illustrating the application of the self-adhesive strap structure. As shown in the figure, the self-adhesive strap is utilized at the collar, sleeve of winter clothing or show garments, or sport shoes for children, ice-skate shoes, and gloves, etc. The self-adhesive strap structure mounted onto these items facilitates buttoning or unbuttoning, and at the same time, a patterned mark can be made on the self-adhesive strap in accordance with the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spint of the present invention.

1. A self-adhesive strap structure facilitating patterned mark formation including a blanket portion having a blanket face and a plastic board body, and a filament-implanting portion having a surface mounted with filaments, and the surface of the blanket-face being provided with a plurality of protruded, hooked blanket bodies, characterized in that the plastic board body is directly ejected via a fabrication molding device onto the rear side of the blanket face, thereby the blanket face is fused with the plastic board body as one unit to form the self-adhesive strap.

2. The self-adhesive strap structure of claim 1, wherein the mold cavity provided at the inner bottom of the molding device is provided with a plurality of needle-like top mold so as to position and support the plastic board body and the blanket face, and the circumferential edge of the molding device slightly presses and positioned the side edge of the blanket face to avoid dislocation of the blanket face in the course of injection molding due to high pressure injection of plastic materials.
